(19) United States
(12) Patent Application Publication
(10) Pub. No.: US 2012/0230828 A1
(43) Pub. Date: Sep. 13, 2012

(54) CYLINDRICAL WINDMILL FOR WIND POWER GENERATION

(75) Inventors: Byung-Sue Ryu, Seoul (KR); Young-Sil Yu, Seoul (KR)

(73) Assignee: YOUNG-SIL YU, SEOUL (KR)

(21) Appl. No.: 13/394,547

(22) PCT Filed: Sep. 3, 2010
(86) PCT No.: PCT/KR2010/006015

§ 371 Date: May 23, 2012

(30) Foreign Application Priority Data
Sep. 7, 2009 (KR) 10-2009-0083907

(51) Int. Cl. F03D 3/02

(52) U.S. Cl. 416/210 R

(57) ABSTRACT

The cylindrical windmill for wind power generation includes: a support frame formed in a cylindrical shape around a rotational shaft; a plurality of wing fixtures protruded from the support frame; a plurality of wing fixing plates, each of which is fixed to the corresponding wing fixture and has elastic properties; and a plurality of wings, each of which is composed of an operating range installed in such a manner that the middle portion between the center and the tip of a wing is fixed to one side of the wing fixing plate to open or close a space that is formed between the wing fixture and the wing fixing plate, and an auxiliary operating range adapted to protrude outside the wing fixture when the space is opened by the operating range.

### TECHNICAL FIELD

The present invention relates to a cylindrical windmill for use in a wind power generation apparatus, and more particularly, to a windmill for wind power generation, in which a section receiving wind power to generate a rotational force is enlarged, thereby effectively utilizing wind energy.

### BACKGROUND OF THE INVENTION

Since existing fossil energy resources pollute the earth environment, as well as being in danger of running out, scientists from different countries have been eagerly looking for apparatuses capable of utilizing an alternative energy source or a green energy source which does not pollute the environment, without being depleted. Such a green alternative energy source includes solar energy, wind energy, current energy, tidal energy, geo-thermal energy, and bio-thermal energy. A wind power generation apparatus has been used as means for generating electricity by use of the wind energy.

In general, the wind power generation apparatus can be divided into a horizontal-axis wind power generation apparatus having a rotational shaft which is horizontally installed to a ground, and a vertical-axis wind power generation apparatus having a rotational shaft which is vertically installed to the ground. The horizontal-axis wind power generation apparatus is more commonly used, and has an advantage of achieving the high efficiency in generation of electricity. However, there are some drawbacks in that it is difficult to generate the electricity, without a hitch, in a case in which a direction of wind is frequently changed or strong wind such as gust blows; since major components including a rotor are installed at a high position, maintenance is not easy; and it is structurally vulnerable to the strong wind such as a very violent tropical storm.

The vertical-axis wind power generation apparatus has advantages of generating the electricity irrespective of the direction, speed or magnitude of the wind, and easily conducting the maintenance of the major components such as speed increaser or generator. Therefore, many studies of the vertical-axis wind power generation apparatus are in progress.

The vertical-axis wind power generation apparatus includes a cylindrical windmill having a plurality of wings provided at an outer surface of a cylindrical rotary frame to convert wind energy into mechanical energy, and a power generating device receiving the mechanical energy from the rotor and converting it into electrical energy.

The wing structure provided to the rotary frame is configured to protrude from the outer surface of the rotary frame, so that wind power smoothly acts on the wing structure. However, the wing structure positioned at a side, in which the turning direction of the rotary frame is opposite to the direction of the wind, generates a resistance to decrease the rotational force of the rotary frame. As a result, there are drawbacks in that the wind energy is lost, and the wing structure is easily broken since an excessive load acts on the wing structure.

In the configuration of the wing structure, in a case in which the wing structure is positioned in such a manner that a turning direction of the rotary frame is identical to the direction of the wind, the wing structure is fully unfolded to effectively receive the wind energy. On the contrary, in a case in which the wing structure is positioned in such a manner that the turning direction of the rotary frame is opposite to the direction of the wind, the wing structure is fully folded or a portion of the wing structure is opened to minimize the resistance to the wing structure. However, since the wing structure is basically configured to protrude from the outer surface of the rotary frame, it is not possible to prevent the resistance to the wing structure from being generated.

The applicant filed a newly designed cylindrical windmill for wind power generation as a patent application in view of the above-described problem. The windmill for wind power generation is disclosed in Korean Patent Application No. 10-2009-0004136 (filing number).

A wing structure of the above-described windmill for wind power generation has a depressed structure extending vertically along an outer surface of a rotary frame and concaved toward an inner portion of the rotary frame, in which the rotary frame is provided with a plurality of wind pressure acting grooves for generating mechanical energy by the wind energy to rotate the rotary frame. A movable blade is hinged to each wind pressure acting groove at one end to open or close the wind pressure acting groove. When the wind pressure acting groove is positioned at a side in which a turning direction of the rotary frame is identical to a rotation direction of the rotary frame, the wind pressure acting groove is opened. On the contrary, when the wind pressure acting groove is positioned at a side in which the turning direction of the rotary frame is opposite to the rotation direction of the rotary frame, the wind pressure acting groove is closed.

The above-described configuration of the windmill for wind power generation has an advantage in that since the wing structure does not protrude outwardly from the rotary frame, the resistance to the wing structure is not generated in fact, and thus the wind energy can be effectively utilized.

However, the above-described configuration of the windmill for wind power generation has a problem in that since wind pressure acting groove has a short to receive the wind energy, the wind energy is not sufficiently utilized.

### DESCRIPTION OF SPECIFIC EMBODIMENTS

### Technical Problem

Therefore, the present invention has been made to solve the above-mentioned problems occurring in the related art, and an object of the present invention is to provide a cylindrical windmill for use in a vertical-axis wind power generation apparatus wind power generation, which can effectively utilize wind energy by enlarging a section receiving wind power while minimizing generation of rotational resistance to wings.

### Technical Solution

In order to accomplish the above-mentioned objects, there is provided a cylindrical windmill for wind power generation, including: a support frame which is formed in a cylindrical shape around a rotational shaft; a plurality of wing fixtures which are provided on the support frame to protrude from the support frame; a plurality of wing fixing plates which are fixed to the wing fixtures; and a plurality of wings which are installed to one side of each wing fixing plate to open or close a space in such a way that an intermediate between a center portion and an end portion is fixed, in which each wing is divided into an operating region for opening or closing the space and an auxiliary operating range protruding outwardly from the wing fixing portion when the space is opened by the operating region.

A shield is further provided at each wing fixing portion, the shield closing a portion of the space formed between the two wing fixtures to form a wind power receiving groove.

With the above-described configuration of the present invention, the point when the space is closed by each wing is delayed, and thus the wind power acts on the space for a longer time to generate a rotational force, thereby more effectively utilizing the power energy.

### BRIEF DESCRIPTION OF THE DRAWINGS

FIG. 1 is a plan view illustrating a windmill for wind power generation according to a preferred embodiment of the present invention.

FIG. 2 is a detailed view illustrating a configuration of major parts of the windmill according to the present invention.

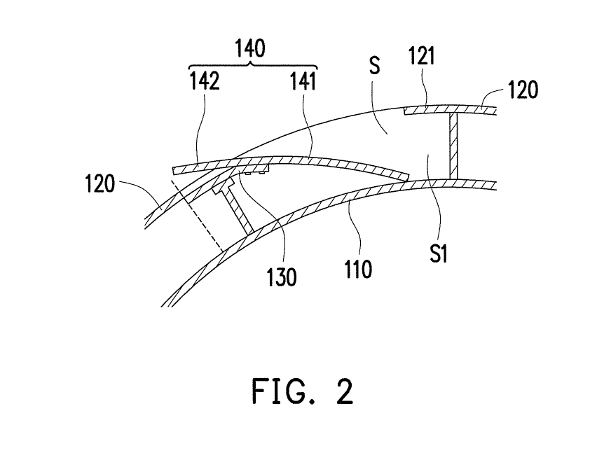

FIG. 3 is a view comparing sections in which a space formed in the windmill according to the present invention and a space formed in a windmill according to a related art are closed.

### DESCRIPTION OF REFERENCE NUMERALS FOR MAJOR COMPONENTS IN THE ACCOMPANYING DRAWINGS

110: support frame, 111: rotational shaft

120: wing fixing portion, 121: shield

130: wing fixing plate, 140: wing

141: operating region, 142: auxiliary operating range

### DESCRIPTION OF SPECIFIC EMBODIMENTS

Now, preferred embodiment of the present invention will be described in detail with reference to the accompanying drawings.

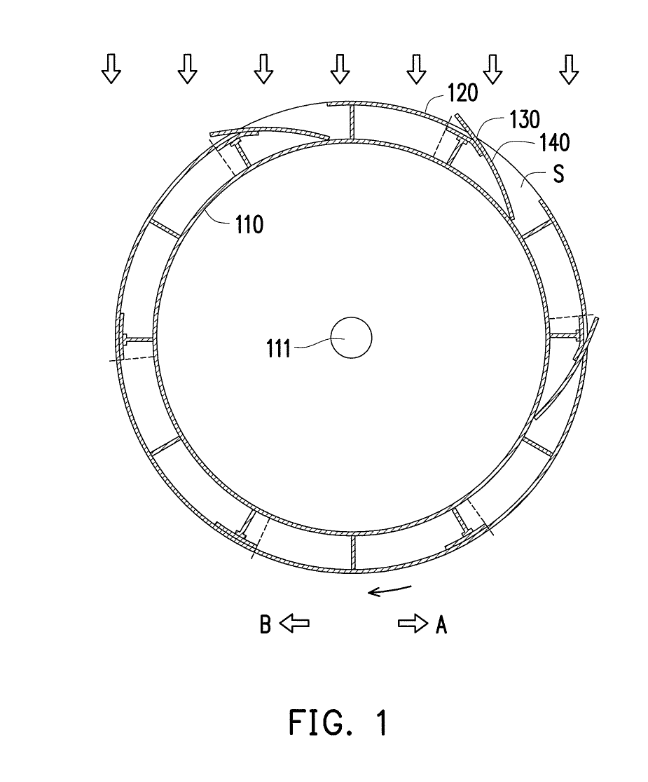

FIG. 1 is a plan view illustrating a windmill for wind power generation according to a preferred embodiment of the present invention.

The windmill for wind power generation according to the present invention is adapted to more effectively utilize wind energy by opening a space S formed in a support frame 110 which is opened or closed by a wing 140 to receive wind power for a time longer than a section receiving the wind power. The windmill for wind power generation according to a preferred embodiment of the present invention includes a support frame 110, a plurality of wing fixtures 120, a plurality of wing fixing plates 130, and a plurality of wings 140.

The support frame 110 is formed in a cylindrical shape, and is provided with a rotational shaft 111 at its center portion. The support frame 110 is integrally connected to the rotational shaft 111, and thus a rotational force generated by rotation of the support frame 110 is transmitted to other device, such as a generator, via the rotational shaft 111.

The plurality of wing fixtures 120 protrudes from the outer surface of the support frame 110 at regular intervals, and extends vertically along the support frame 110. A space S is formed between the plurality of wing fixtures 120 formed on the outer surface of the support frame 110, and the wind power acts on the space S to generate the rotational force.

The plurality of wing fixing plates 130 fixes each wing 140 to the wing fixing portion 120, and supports the wing in such a manner that each wing 140 is turned by a force such as wind power or centrifugal force. The wing fixing plate 130 is made of a spring plate to have resilience, and one end portion f the wing is fixed to one side of the wing fixing portion 120.

In a case in which the space S receiving the wind power is positioned at a side A in which a turning direction of the windmill is identical to a direction of the wind, the plurality of wings 140 opens the space S, so that the space S receives the wind power to generate the rotational force. On the contrary, in a case in which the space S is positioned at a side B in which the turning direction of the windmill is opposite to the direction of the wind, the plurality of wings 140 closes the space S to prevent a rotational resistance to the space from being generated.

The plurality of wings 140 is installed to one side of each wing fixing plate 130 to open or close each space S in such a way that an intermediate between a center portion and an end portion is fixed. The wing is divided into an operating region 141 for opening or closing the space S and an auxiliary operating range 142 protruding outwardly from the wing fixing portion 120 to maintain the open state of the space S when the space S is opened by the operating region 141, on the basis of the portion fixed to the wing fixing plate 130.

Meanwhile, in order to generate stronger rotational force by use of the wind power flowing in the space S, it is preferable to further form a shield 121 at each wing fixing portion 120, the shield 121 closing a portion of the space S. In this instance, the shield 121 is installed to the wing fixing portion 120 so as to position at a side opposite to the wing fixing plate 130. In other words, one side of the wing fixing portion 120 is provided with the wing fixing plate 130, and the other side is provided with the shield 121.

The shield 121 prevents the loss of the wind flowing in the space S to generate the stronger rotational force. In addition, when the space S is closed by the wing 140, it is possible to block the wing 140 from protruding outwardly from the wing fixing portion 120 due to the centrifugal force or the resilience of the wing fixing plate 130.

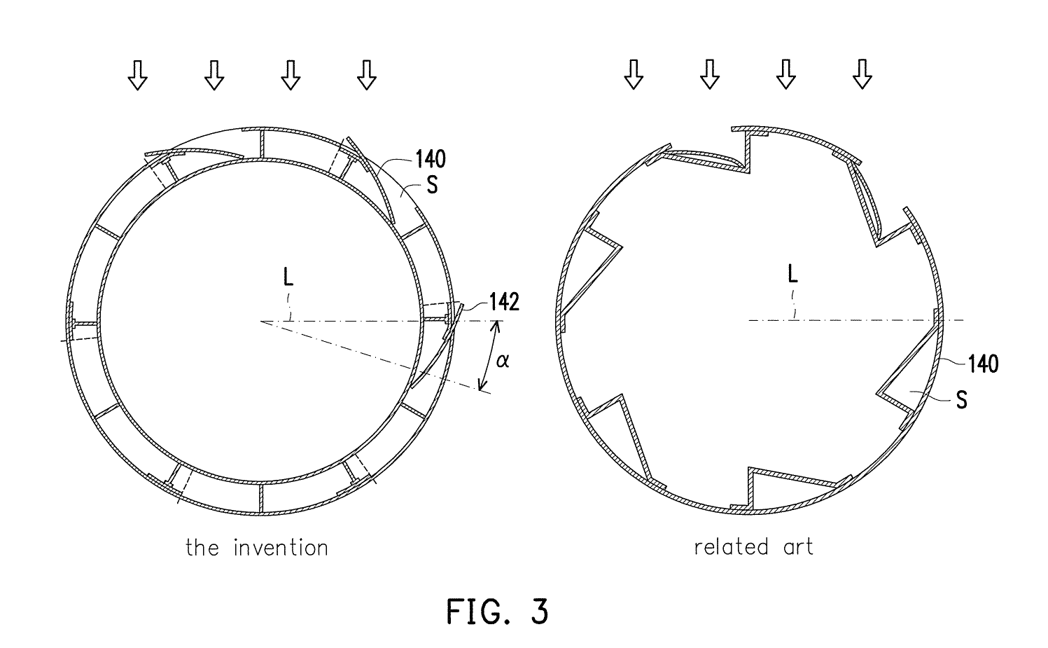

FIG. 3 is a view comparing sections in which the space formed in the windmill according to the present invention and a space formed in a windmill according to a related art are closed.

As described above, when the space S receiving the wind power to generate the rotational force is positioned at the side A in which the turning direction of the windmill is identical to the direction of the wind, the wind power acts on the wing 140, and thus the wing 140 is turned, thereby opening the space S.

Timing of opening the spaces S in two windmills shown in FIG. 3 is identical to each other, but the space S is closed more lately in the windmill according to the present invention. Since there is no portion protruding outwardly when the space S is opened in the windmill according to the related art, the wind power does not act on the wing 140′ at a point when the space S passes through a reference line L indicated on the drawing. Therefore, the wing 140′ is returned to its original position by the centrifugal force, and thus the space S is closed.

According to the present invention, however, since the state in which the auxiliary operating range 142 of the wing 140 protrudes outwardly from the wing fixing portion 120 at the point when the space S passes through the reference line L, the wind power still acts on the wing 140, and thus the closing of the space S by the wing 140 is delayed. The delayed closing of the space S is achieved until the wind power does not act on the auxiliary operating range 142, and thus the space S is more opened by a section a illustrated in the drawing in the windmill according to the present invention, as compared with the windmill according to the related art, thereby more effectively utilizing the wind power.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A cylindrical windmill for wind power generation, comprising:
a support frame which is formed in a cylindrical shape around a rotational shaft;
a plurality of wing fixtures which are provided on the support frame to protrude from the support frame;
a plurality of wing fixing plates which are fixed to the wing fixtures; and
a plurality of wings which are installed to one side of each wing fixing plate to open or close a space in such a way that an intermediate between a center portion and an end portion is fixed, in which each wing is divided into an operating region for opening or closing the space and an auxiliary operating range protruding outwardly from the wing fixing portion when the space is opened by the operating region.

2. The cylindrical windmill for wind power generation according to claim 1, further comprising a shield provided at each wing fixing portion, the shield closing a portion of the space formed between the two wing fixtures to form a wind power receiving groove.
